(19) United States
(12) Patent Application Publication
(10) Pub. No.: US 2022/0134432 A1
(43) Pub. Date: May 5, 2022

(54) THREE-DIMENSIONAL SHAPING APPARATUS

(71) Applicant: SEIKO EPSON CORPORATION, Tokyo (JP)

(72) Inventor: Takeshi MIYASHITA, SENDAI-SHI (JP)

(21) Appl. No.: 17/452,619

(22) Filed: Oct. 28, 2021

(30) Foreign Application Priority Data
Oct. 30, 2020 (JP) 2020-182320

(51) Int. Cl. B22F 10/14; B22F 10/36; B22F 12/55; B33Y 30/00; B33Y 50/02; B29C 64/165; B29C 64/393; B29C 64/336

(52) U.S. Cl. CPC B22F 10/14; B22F 10/36; B22F 12/55; B29C 64/336; B33Y 50/02; B29C 64/165; B29C 64/393; B33Y 30/00

(57) ABSTRACT

A three-dimensional shaping apparatus includes a stage, a material supply unit that supplies a material containing an inorganic powder and a binder, a laser, and a control unit, and the control unit performs a process of supplying the material onto the stage by controlling the material supply unit, and a process of irradiating the material on the stage with a laser beam with an energy density of 140 J/mm³ or more by controlling the laser.

The present application is based on, and claims priority from JP Application Serial Number 2020-182320, filed Oct. 30, 2020, the disclosure of which is hereby incorporated by reference herein in its entirety.

### BACKGROUND

### 1. Technical Field

The present disclosure relates to a three-dimensional shaping apparatus.

### 2. Related Art

A three-dimensional shaping apparatus that shapes a three-dimensional shaped article is known.

For example, JP-A-2008-184622 describes a method for producing a three-dimensional shaped article by supplying a material containing a metal powder, a solvent, and an adhesive enhancer to a plate for shaping, and irradiating the material with a laser beam.

However, when a material containing a metal powder and an adhesive enhancer is irradiated with a laser beam as described above, the adhesive enhancer having a low boiling point is first vaporized before the metal powder is melted or sintered by the laser beam, and the metal powder may sometimes be scattered. When the metal powder is scattered, the thickness of the three-dimensional shaped article varies or the like, that is, the shaping accuracy is deteriorated.

### SUMMARY

One aspect of a three-dimensional shaping apparatus according to the present disclosure includes a stage, a material supply unit that supplies a material containing an inorganic powder and a binder, a moving unit, a laser, and a control unit, in which the control unit performs a process of supplying the material onto the stage by controlling the material supply unit, and a process of irradiating the material on the stage with a laser beam with an energy density of 140 J/mm³ or more by controlling the laser.

### BRIEF DESCRIPTION OF THE DRAWINGS

FIG. 1 is a cross-sectional view schematically showing a three-dimensional shaping apparatus according to the present embodiment.

FIG. 2 is a flowchart for explaining processes of a control unit of the three-dimensional shaping apparatus according to the present embodiment.

FIG. 3 is a cross-sectional view schematically showing a step of producing a three-dimensional shaped article to be produced by the three-dimensional shaping apparatus according to the present embodiment.

FIG. 4 is a cross-sectional view schematically showing a step of producing a three-dimensional shaped article to be produced by the three-dimensional shaping apparatus according to the present embodiment.

FIG. 5 is a table showing a relationship between an energy density of a laser beam and a residual film ratio and a surface roughness Sz of a shaped layer.

FIG. 6 is a graph showing a relationship between an energy density of a laser beam and a residual film ratio of a shaped layer.

FIG. 7 is a graph showing a relationship between an energy density of a laser beam and a surface roughness Sz of a shaped layer.

### DESCRIPTION OF EXEMPLARY EMBODIMENTS

Hereinafter, preferred embodiments of the present disclosure will be described in detail using the drawings. Note that the embodiments described below are not intended to unduly limit the contents of the present disclosure described in the appended claims. Further, all the configurations described below are not necessarily essential configuration requirements of the present disclosure.

### 1. Three-Dimensional Shaping Apparatus

### 1.1. Overall Configuration

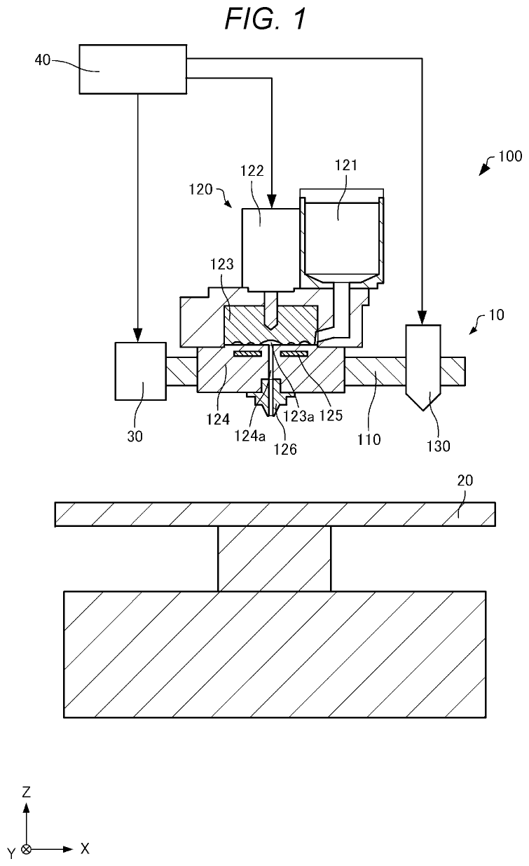

First, a three-dimensional shaping apparatus according to the present embodiment will be described with reference to the drawings. FIG. 1 is a cross-sectional view schematically showing a three-dimensional shaping apparatus 100 according to the present embodiment. Note that in FIG. 1, as three axes orthogonal to one another, X axis, Y axis, and Z axis are shown. An X-axis direction and a Y-axis direction are each, for example, a horizontal direction. A Z-axis direction is, for example, a vertical direction.

The three-dimensional shaping apparatus 100 includes, for example, a shaping unit 10, a stage 20, a moving unit 30, and a control unit 40 as shown in FIG. 1.

The shaping unit 10 includes, for example, a support member 110, a material supply unit 120, and a laser 130.

The support member 110 is, for example, a plate-shaped member. The support member 110 supports the material supply unit 120 and the laser 130.

The material supply unit 120 supplies a material onto the stage 20. The material to be supplied will be described later. The material supply unit 120 includes, for example, a material introduction portion 121, a motor 122, a flat screw 123, a barrel 124, a heater 125, and a nozzle 126.

The material introduction portion 121 of the material supply unit 120 introduces a material into a groove 123a provided in a face at the barrel 124 side of the flat screw 123. The material to be introduced into the groove 123a is, for example, in a powder form. The flat screw 123 is rotated by the motor 122. The heater 125 is provided in the barrel 124. The material is plasticized in the groove 123a by the heat of the heater 125. The plasticized material passes through a communication hole 124a provided in the barrel 124, and is ejected to the stage 20 from the nozzle 126. The ejected material becomes in a state where fluidity is lost on the stage 20.

The laser 130 irradiates the material on the stage 20 with a laser beam. The laser is, for example, a YAG (Yttrium Aluminum Garnet) laser, a fiber laser, a UV (ultraviolet) laser, or the like.

The laser beam has a square top hat shape. The laser beam having a square top hat shape has highly uniform flat top and steep boundary characteristics as compared to a laser beam having a Gaussian shape.

The stage 20 is provided below the shaping unit 10. On the stage 20, the material is supplied and a three-dimensional shaped article is formed.

The moving unit 30 changes the relative position of the shaping unit 10 to the stage 20. The moving unit 30, for example, simultaneously changes the relative position between the stage 20 and the material supply unit 120, and the relative position between the stage 20 and the laser 130. In the illustrated example, the stage 20 is fixed, and the moving unit 30 moves the shaping unit 10 with respect to the stage 20. According to this, the relative positions between the stage 20 and the material supply unit 120 and between the stage 20 and the laser 130 can be changed. In the illustrated example, the moving unit 30 is coupled to the support member 110, and moves the shaping unit 10 by moving the support member 110.

The moving unit 30 is constituted by, for example, a three-axis positioner for moving the shaping unit 10 in the X-axis direction, Y-axis direction, and Z-axis direction by the driving forces of unillustrated three motors. The motors of the moving unit 30 are controlled by the control unit 40.

The moving unit 30 may be configured to move the stage 20 without moving the shaping unit 10. In this case, the moving unit 30 is coupled to the stage 20. Further, the moving unit 30 may be configured to move both the shaping unit 10 and the stage 20. In this case, the moving unit 30 is coupled to both the shaping unit 10 and the stage 20.

The control unit 40 is constituted by, for example, a computer including a processor, a main storage device, and an input/output interface for performing signal input/output to/from the outside. The control unit 40 exhibits various functions, for example, by execution of a program read in the main storage device by the processor. The control unit 40 controls the shaping unit 10 and the moving unit 30. Specific processes of the control unit 40 will be described later. The control unit 40 may be constituted by a combination of multiple circuits instead of a computer.

### 1.2. Material

The material to be supplied onto the stage 20 by the material supply unit 120 contains an inorganic powder and a binder. The material of the inorganic powder is, for example, a metal or a ceramic. The material to be supplied by the material supply unit 120 may contain both a metal powder and a ceramic powder.

Examples of the metal include single metals of magnesium (Mg), iron (Fe), cobalt (Co), chromium (Cr), aluminum (Al), titanium (Ti), copper (Cu), and nickel (Ni), or alloys containing one or more of these metals, and a maraging steel, a stainless steel (SUS), cobalt-chromium-molybdenum, a titanium alloy, a nickel alloy, an aluminum alloy, a cobalt alloy, and a cobalt-chromium alloy.

Examples of the ceramic include oxide ceramics such as silicon dioxide, titanium dioxide, aluminum oxide, and zirconium oxide, and non-oxide ceramics such as aluminum nitride.

Examples of the binder include synthetic resins such as an acrylic resin, an epoxy resin, a silicone resin, and PVA (polyvinyl alcohol). The binder binds the inorganic powders together in a state before being irradiated with a laser beam. The binder is vaporized, for example, by irradiation with a laser beam.

The content of the binder in the material to be ejected from the nozzle 126 is, for example, 6 mass % or more and 9 mass % or less, and preferably 7.5 mass % or more and 8.5 mass % or less. When the content of the binder is 6 mass % or more, the lubricity of the material can be enhanced, and the material can be ejected from the nozzle 126. When the content of the binder is 9 mass % or less, cost reduction can be achieved. The material to be ejected from the nozzle 126 is a material before being irradiated with a laser beam.

### 1.3. Processes of Control Unit

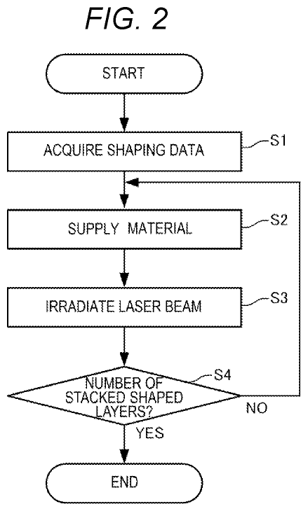

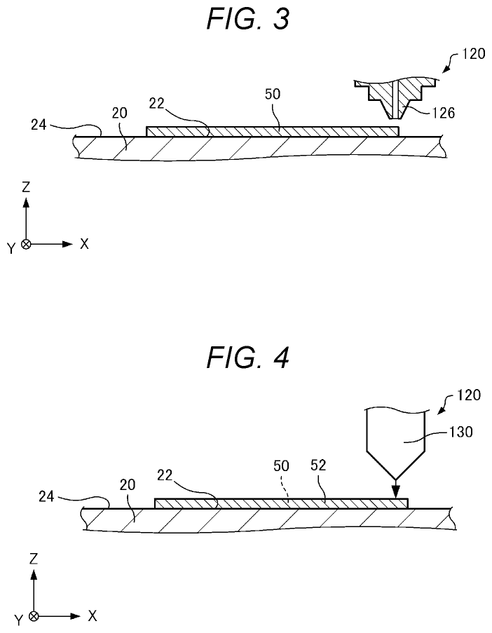

The control unit 40 controls the moving unit 30, the material supply unit 120, and the laser 130. FIG. 2 is a flowchart for explaining processes of the control unit 40. FIGS. 3 and 4 are cross-sectional views schematically showing a step of producing a three-dimensional shaped article to be produced by the three-dimensional shaping apparatus 100.

A user, for example, operates an unillustrated operation unit and transmits a process start signal to the control unit 40. The operation unit is realized by, for example, a mouse, a keyboard, a touch panel, or the like. The control unit 40 starts a process as shown in FIG. 2 when receiving the process start signal.

First, the control unit 40 performs a process of acquiring shaping data (Step S1). The shaping data are shaping data for shaping a three-dimensional shaped article. The shaping data include information regarding the shape, size, material, etc. of the three-dimensional shaped article to be shaped. The processes of the control unit 40 described below are performed based on the shaping data. The shaping data are generated by, for example, slicer software installed on the computer coupled to the three-dimensional shaping apparatus 100. The control unit 40 acquires the shaping data from the computer coupled to the three-dimensional shaping apparatus 100 or a recording medium such as a USB (Universal Serial Bus) memory.

Subsequently, the control unit 40 performs a process of supplying a material 50 onto the stage 20 by controlling the material supply unit 120 as shown in FIG. 3 while moving the shaping unit 10 with respect to the stage 20 by controlling the moving unit 30 (Step S2).

In Step S2, the control unit 40 supplies the material 50 to a first region 22 of the stage 20 and does not supply the material 50 to a second region 24 of the stage 20. That is, the control unit 40 supplies the material 50 only to the first region 22. The second region 24 is a region that is different from the first region 22. The second region 24, for example, surrounds the first region 22 when viewed from the Z-axis direction.

Subsequently, the control unit 40 performs a process of irradiating the material 50 on the stage 20 with a laser beam by controlling the laser 130 as shown in FIG. 4 while moving the shaping unit 10 with respect to the stage by controlling the moving unit 30 (Step S3). By irradiating the material 50 with a laser beam, the material 50 is sintered or melted, whereby a shaped layer 52 having high flatness can be formed.

In Step S3, the control unit 40 performs the process of irradiating the material 50 on the stage 20 with a laser beam with an energy density of 140 J/mm³ or more. When the energy density of the laser beam is 140 J/mm³ or more, as in the below-mentioned Experimental Example, the residual film ratio can be increased, and scattering of the inorganic powder can be suppressed. In this manner, in the three-dimensional shaping apparatus 100, a three-dimensional shaped article is shaped by irradiation with a laser beam with an energy density of 140 J/mm³ or more. The energy density of the laser beam is preferably 145 J/mm³ or more.

In Step S3, the irradiation with a laser beam is performed with such an energy density that the boiling point of the inorganic powder contained in the material 50 is not exceeded. If a laser beam is irradiated with such an energy density that the boiling point of the inorganic powder is exceeded, the inorganic powder is vaporized to decrease the amount of the inorganic powder. The energy density of the laser beam is, for example, 500 J/mm³ or less, preferably 400 J/mm³ or less, and more preferably 350 J/mm³ or less. When the energy density of the laser beam is, for example, 500 J/mm³ or less, energy saving can be achieved.

In Step S3, the control unit 40 performs control according to a relational formula represented by the formula (1). For example, when a coating thickness d is set to 100 μm, the output Pw of the laser beam is set to 500 W, and the beam width Db of the laser beam is set to 200 μm, the control unit 40 performs control so that the scanning speed S of the laser beam is 180 mm/sec or less, and the energy density Eg is 140 J/mm³ or more.

Eg=Pw/(Db×S×d) (1)

Subsequently, the control unit 40 performs a process of determining whether or not the number of stacked shaped layers 52 becomes a predetermined number based on the acquired shaping data (Step S4). When it is determined that the number of stacked shaped layers 52 does not become the predetermined number (“NO” in Step S4), the control unit 40 returns the process to Step S2 and repeats Step S2 and Step S3 until the number of stacked shaped layers 52 becomes the predetermined number. When it is determined that the number of stacked shaped layers 52 becomes the predetermined number (“YES” in Step S4), the control unit 40 terminates the process.

### 1.4. Operational Effects

In the three-dimensional shaping apparatus 100, the control unit 40 performs the process of supplying the material 50 onto the stage 20 by controlling the material supply unit 120 and the process of irradiating the material 50 on the stage 20 with a laser beam with an energy density of 140 J/mm³ or more by controlling the laser 130. Therefore, in the three-dimensional shaping apparatus 100, as in the below-mentioned Experimental Example, the residual film ratio of the shaped layer 52 can be increased, and scattering of the inorganic powder can be suppressed. Accordingly, the thickness of the three-dimensional shaped article can be stabilized.

In the three-dimensional shaping apparatus 100, the material supply unit 120 includes the nozzle 126 that ejects the material 50, and the content of the binder in the material 50 before being irradiated with the laser beam is 6 mass % or more and 9 mass % or less. Therefore, in the three-dimensional shaping apparatus 100, the material 50 can be ejected from the nozzle 126 while achieving cost reduction.

In the three-dimensional shaping apparatus 100, the laser beam has a square top hat shape. Therefore, in the three-dimensional shaping apparatus 100, as in the below-mentioned Experimental Example, the surface roughness (maximum height) Sz of the shaped layer 52 can be decreased as compared to a case where the laser beam has a Gaussian shape.

In the three-dimensional shaping apparatus 100, in the process of supplying the material 50, the control unit 40 supplies the material 50 to the first region 22 of the stage 20 and does not supply the material 50 to the second region 24 that is different from the first region 22 of the stage 20. For example, in a PBF (Powder Bed Fusion) system in which the material is supplied to the entire face of the stage using a hopper as the material supply unit, even if scattering of the inorganic powder occurs and the thickness of a first shaped layer varies, the thickness can be made uniform in supplying the material for a second shaped layer to be formed on the first shaped layer. On the other hand, in an FDM (Fused Deposition Modeling) or PIJ (paste inkjet) system in which the material supply unit includes a nozzle, the material is selectively supplied onto the stage, and therefore, when the thickness of the first shaped layer varies, it is difficult to recover the variation in thickness in supplying the material for the second shaped layer. Therefore, the three-dimensional shaping apparatus 100 has a high effect when it supplies the material 50 to the first region 22 of the stage 20 and does not supply the material 50 to the second region 24.

In the above-mentioned example, an example in which the relative positions between the stage 20 and the material supply unit 120 and between the stage 20 and the laser 130 can be simultaneously changed is described, however, the material supply unit 120 and the laser 130 may be configured to be separately moved. Further, the laser 130 is fixed, and the laser beam may be moved using a Galvano mirror. In this case, the Galvano mirror is controlled by the control unit 40.

Further, in the above-mentioned example, an example using the flat screw 123 is described, however, in place of the flat screw 123, an in-line screw or a head using an FDM method may be used.

### 2. Experimental Example

A material containing SUS 630 powder as the inorganic powder and PVA as the binder was prepared. The content of PVA in the material was set to 8 mass %. This material was supplied onto the stage from the nozzle and irradiated with a laser beam. As the laser beam, two types: a laser beam having a square top hat shape; and a laser beam having a Gaussian shape were used. The irradiation energy density was made to vary by adjusting the beam width, output, and scanning speed of the laser beam.

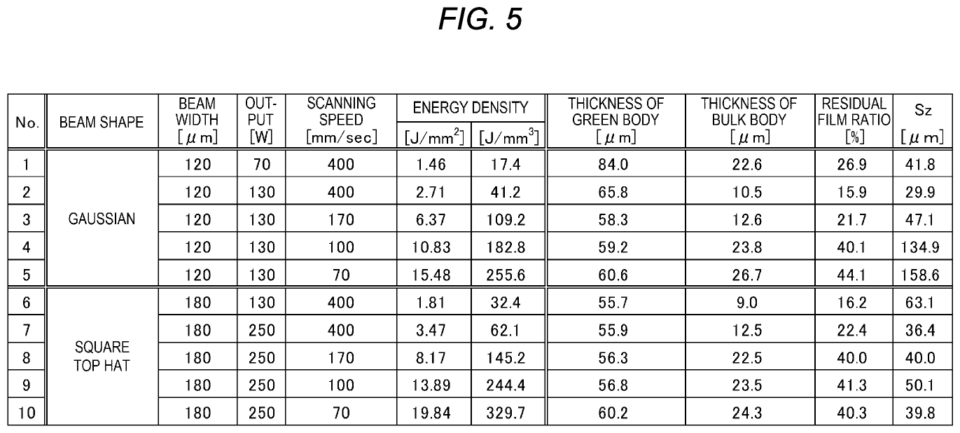

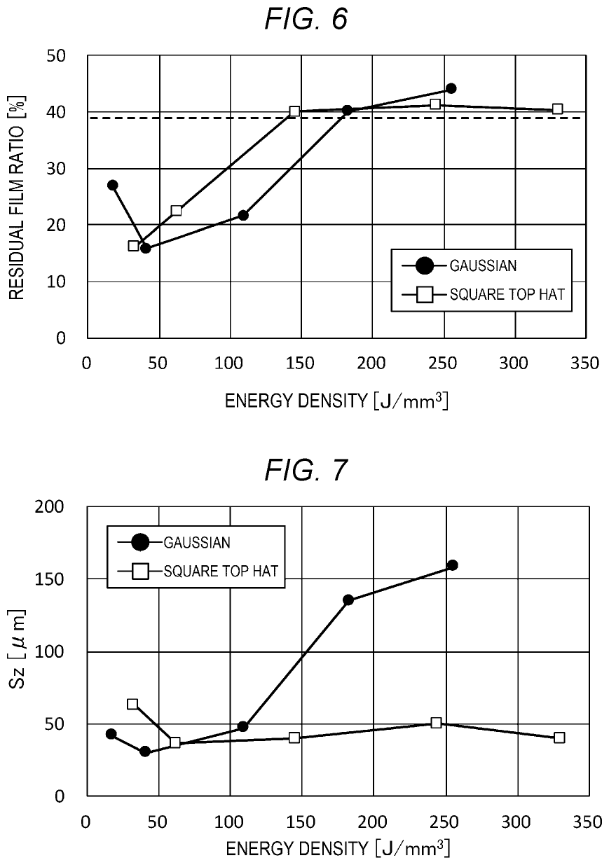

FIG. 5 is a table showing a relationship between an energy density of the laser beam and a residual film ratio and a surface roughness Sz of the shaped layer. FIG. is a graph showing a relationship between an energy density of the laser beam and a residual film ratio of the shaped layer. FIG. 7 is a graph showing a relationship between an energy density of the laser beam and a surface roughness Sz of the shaped layer. FIGS. 6 and 7 are each a graph obtained by plotting the values shown in FIG. 5. The surface roughness Sz was measured using a one-shot 3D shape measuring machine VR-3200 manufactured by KEYENCE CORPORATION.

In FIG. 5, the residual film ratio is a ratio of the thickness of a bulk body to the thickness of a green body. The green body is a material supplied to the stage and is a material in a state before being irradiated with the laser beam. The bulk body is a material supplied to the stage and is a material in a state after being irradiated with the laser beam.

As shown in FIGS. 5 and 6, when the energy density of the laser beam was 140 J/mm³ or more, the residual film ratio was about 40%. Here, the content of the SUS powder in the green body was 38.4 vol %. Therefore, it can be said that if the residual film ratio is about 40%, scattering of the SUS powder by irradiation with the laser beam does not occur. In FIG. 6, the residual film ratio of 38.4% is indicated by a broken line. Note that the residual film ratio exceeding 38.4 vol % is an error. When the energy density of the laser beam is small, the SUS powder is scattered due to volume expansion when PVA is vaporized, and therefore, the residual film ratio becomes small.

As shown in FIGS. 5 and 6, when the laser beam had a square top hat shape, as compared to the case of having a Gaussian shape, even if the energy density was small, the residual film ratio was about 40%. Further, as shown in FIGS. 5 and 7, when the laser beam had a square top hat shape, as compared to the case of having a Gaussian shape, the surface roughness Sz was small. When the laser beam had a Gaussian shape, as compared to the case of having a square top hat shape, the temperature was locally high. Therefore, scattering of the SUS powder is likely to occur, and the surface roughness Sz becomes large.

The present disclosure includes substantially the same configuration, for example, a configuration having the same function, method, and result, or a configuration having the same object and effect as the configuration described in the embodiments. Further, the present disclosure includes a configuration in which a part that is not essential in the configuration described in the embodiments is substituted. Further, the present disclosure includes a configuration having the same operational effect as the configuration described in the embodiments, or a configuration capable of achieving the same object as the configuration described in the embodiments. In addition, the present disclosure includes a configuration in which a known technique is added to the configuration described in the embodiments.

From the above-mentioned embodiments, the following contents are derived.

One aspect of a three-dimensional shaping apparatus includes a stage, a material supply unit that supplies a material containing an inorganic powder and a binder, a laser, and a control unit, in which the control unit performs a process of supplying the material onto the stage by controlling the material supply unit, and a process of irradiating the material on the stage with a laser beam with an energy density of 140 J/mm³ or more by controlling the laser.

According to the three-dimensional shaping apparatus, scattering of the inorganic powder can be suppressed.

In one aspect of the three-dimensional shaping apparatus, the material supply unit may have a nozzle that ejects the material, and a content of the binder in the material before being irradiated with the laser beam may be 6 mass % or more and 9 mass % or less.

According to the three-dimensional shaping apparatus, the material can be ejected from the nozzle while achieving cost reduction.

In one aspect of the three-dimensional shaping apparatus, the laser beam may have a square top hat shape.

According to the three-dimensional shaping apparatus, the surface roughness Sz of the shaped layer can be decreased as compared to a case where the laser beam has a Gaussian shape.

In one aspect of the three-dimensional shaping apparatus, the control unit may supply the material to a first region of the stage and need not supply the material to a second region that is different from the first region of the stage in the process of supplying the material.

What is claimed is:

1. A three-dimensional shaping apparatus, comprising:
a stage;
a material supply unit that supplies a material containing an inorganic powder and a binder;
a laser; and
a control unit, wherein
the control unit performs
a process of supplying the material onto the stage by controlling the material supply unit, and
a process of irradiating the material on the stage with a laser beam with an energy density of 140 J/mm³ or more by controlling the laser.

2. The three-dimensional shaping apparatus according to claim 1, wherein
the material supply unit has a nozzle that ejects the material, and
a content of the binder in the material before being irradiated with the laser beam is 6 mass % or more and 9 mass % or less.

3. The three-dimensional shaping apparatus according to claim 1, wherein
the laser beam has a square top hat shape.

4. The three-dimensional shaping apparatus according to claim 1, wherein
the control unit supplies the material to a first region of the stage and does not supply the material to a second region that is different from the first region of the stage in the process of supplying the material.
